(19) United States
(12) Patent Application Publication
(10) Pub. No.: US 2014/0229250 A1
(43) Pub. Date: Aug. 14, 2014

(54) RATING OF DIGITAL PRODUCTS

(71) Applicant: Jim Hodson, Monroe, CT (US)

(72) Inventor: Jim Hodson, Monroe, CT (US)

(21) Appl. No.: 14/163,911

(22) Filed: Jan. 24, 2014

Related U.S. Application Data
(60) Provisional application No. 61/865,864, filed on Aug. 14, 2013.
(60) Provisional application No. 61/763,013, filed on Feb. 11, 2013.

(51) Int. Cl. G06Q 30/02

(52) U.S. Cl. CPC G06Q 30/0282; G06Q 30/0217
USPC 705/14.2; 705/347; 705/14.19

(57) ABSTRACT

Methods, systems and machine readable programs on non-transient media for rating of products (such as pre-production digital products) are provided. A pre-production copy of a rhythmic audio composition (e.g. musical product) can be offered for sale online. The musical product can be rated based on a number of the sold pre-production recordings or streams, as well as other factors and purchasers may be rewarded for their music evaluation skills.

### CROSS-REFERENCE TO RELATED APPLICATIONS

This application claims the benefit of U.S. Provisional Patent Application No. 61/865,864 filed Aug. 14, 2013 and U.S. Provisional Patent Application No. 61/763,013 filed Feb. 11, 2013. Each of the aforementioned patent applications is incorporated by reference herein in its entirety for any purpose whatsoever.

### BACKGROUND

1. Field of the Disclosure

The present disclosure relates to techniques for pre-production and early release rating of musical products, among other products available in a digital form or in a form of computer-readable media.

2. Background of the Disclosure

There are many releases of new musical products (presently, about 60,000 titles per month in the USA alone), computer games, applications/programs for processor-enabled apparatuses and the like. These products involve a high cost of commercialization. The present disclosure provides techniques for objective pre-production rating of the musical products and subsequent ongoing ratings to assess their commercial potential in the worldwide marketplace to make the market more efficient.

### SUMMARY

Methods and network-based (e.g., Internet-based) platforms and related processor-readable machine readable programs on non-transient media for pre-production rating of musical products are provided herein. A low-cost pre-production copy or early release of a respective musical product can be produced and offered for sale on such a platform, such as a specialized website. The musical product can be selected or postponed for commercialization based on a number of sold pre-production copies thereof. Users of the platform may be rewarded for their music evaluation skills. The platform may be utilized by a user on any desired device, such as desktop computer, remote terminal, mobile PC, tablet, smart phone and the like.

In accordance with a further aspect of the disclosure, Applicant has appreciated that a significant part of the costs of commercialization of a rhythmic audio composition (or other work) can be marketing and promotion. As such, in some implementations, the disclosed embodiments can be used to determine which rhythmic audio compositions (or other works) already released deserve further investment in market promotion.

In other embodiments, such techniques can be used for pre-production rating of computer games, digital art (such as a work of art that has been digitized, or a work of art that has been created digitally), videos, and applications/programs for computerized devices, and similar products. For example, the video can include a digital video composition, a music video, a movie such as a documentary, independent film or other film, a television show, a commercial, a film short, and the like.

In still further implementations, the disclosed embodiments can be used, for example, by a content distributor to help decide which underperforming finished or fully produced works to expend promotional resources on.

In some implementations, the disclosure provides a method for pre-production rating of a musical product. The method includes receiving a computer-compatible recording of the musical product via processor, uploading the recording of the musical product onto a computer network accessible platform by a plurality of users via processor, providing the platform with tools to permit a user to listen to the musical product and promote selling recordings of the product via processor, and rating the musical product based at least in part on a number of recordings purchased or streamed by users of the platform via processor.

In further accordance with the disclosure, the musical product can include at least one recorded rhythmic audio composition. If desired, the recording can include a pre-production version, a promotional version, a trial version and/or a partial version of the musical product. In some implementations, the recording can include an un-promoted or under-promoted or self-promoted production version for which a provider is seeking at least one objective indicator of commercial viability. If desired, the musical product can include at least a portion of a recording. In some embodiments, the platform can include a website hosted on at least one server of a network. In some implementations, the network is coupled to the Internet. The network can be a multi-user network.

In some implementations, the method can further include promoting the musical product through a means of online communications via processor and performing at least one of (i) selling a recording of the musical product in a form of a computer download via processor, and (ii) streaming a recording of the musical product via a computer network. The method can also include offering to a purchasers of the recording of the musical product monetary, tangible or non-tangible rewards via processor. In some implementations, the method can include calculating ratings of the users using at least one pre-determined algorithm via processor, and rewarding the users based on numerical values their ratings via processor. If desired, the algorithms can use weighted data that may include at least one of (i) a number of purchased recordings of the musical product, (ii) a number of streams of the musical product, (iii) a duration of a period of selling the recordings of the musical product, (iv) a monetary value of the purchased recordings or streams of the musical product, (v) timing of purchases of the recordings of the musical product, (vi) a genre, (vii) a geographic location of at least one user, (viii) common relationship between users of the musical product, and (ix) a number of sold recordings of production/commercial versions the musical product.

In some embodiments, the disclosure provides a method for rating a product available in a digital form or in a form of computer-readable media. The method includes receiving a computer-compatible digital file via processor of the product, uploading the file onto a network accessible by the general public via processor, providing the network with an interface having with tools for evaluating the product and selling units of the product via processor, and rating the product based at least in part on a number of the units purchased or streamed by users of the network via processor.

In some implementations, the product can be a pre-production version, a promotional version, a trial version, or a partial version of (i) a rhythmic audio composition, (ii) a computer game, and/or (iii) an application or program for a processor-enabled apparatus. The product can include a production version for which a provider of the product is seeking at least one objective indicator of commercial viability. In some implementations, the product can include one or more of (i) an under-promoted production version, (ii) a product that has had limited promotion, (iii) a product that has been promoted by the creator or owner of the product, and (iv) a product that has been promoted without dedicated promotional funding (e.g., via social media).

In some embodiments, the method can further include promoting the product through online communication, and selling the product in a computer downloadable format or streaming a sample of the product through a network to a user on the network. If desired, the method can further include offering monetary, tangible or non-tangible rewards to purchasers of the product via processor. Moreover, the method can further include calculating ratings of the users using pre-determined algorithms via processor, and rewarding the users based on numerical values their ratings. If desired, the algorithms can use weighted data including at least one of (i) a number of the purchased units of the product, (ii) a number of the streams of the product, (iii) a duration of a period of selling the units of the product, a monetary value of the units of the purchased product, timing of purchases of the units of the product, a type of the product, a geographical location of a user of the portal, a common relationship between a plurality of users of the portal, and a number of sold units of production/commercial versions of the product.

The disclosure also provides embodiments of a portal accessible by the general public and hosted on at least one server of a computer network. The portal generally includes tools for downloading a digital copy of a product available in a digital form or in a form of computer-readable media, tools for evaluating the product and selling copies of the product, and tools for rating the product based on a number of the copies purchased by users of the portal.

In some embodiments, the portal may be a web portal connected to the Internet. The product can be a pre-production version, a promotional version, a trial version, or a partial version of (i) a rhythmic audio composition, (ii) a computer game, or (iii) an application or program for a processor-enabled apparatus. The portal can further include tools for promoting the product through a means of online communications, and tools for selling the copies of the product in a form of computer downloads. In further aspects the portal can include tools for offering monetary, tangible and/or non-tangible rewards to purchasers of the copies of the product. If desired, the portal can include tools for calculating ratings of the users using pre-determined or other algorithms, and rewarding the users based on numerical values their ratings. The algorithms can, for example, use weighted data including at least one of (i) number of the purchased units of the product, (ii) a number of the streams of the product, (iii) a duration of a period of selling the units of the product, (iv) a monetary value of the units of the purchased product, (v) timing of purchases of the units of the product, (vi) a type of the product, (vii) a geographical location of a user of the portal, (viii) a common relationship between a plurality of users of the portal, and a number of sold units of production/commercial versions of the product.

The disclosure also provides embodiments of a non-transient computer readable medium including a computer program for rating a product. The computer readable medium typically includes computer program code for uploading a computer readable unit of the product onto a computer network portal accessible by the general public, computer program code for providing tools for sampling the product and selling copies of the product on the portal, and computer program code for rating the product on the portal based at least in part on a number of the units purchased by users of the platform.

In some implementations, the product can include a pre-production version, a promotional version, a trial version or a partial version of a rhythmic audio composition. The medium can further include computer program code for promoting the product through online communication, and computer program code for selling the units of the product in a form of a computer download. If desired, the medium can further include computer program code for offering monetary, tangible or non-tangible rewards to purchasers of the units of the product. In some embodiments, the medium can further include computer program code for calculating ratings of the users using pre-determined algorithms, and computer program code for rewarding the users based on numerical values of their ratings. The algorithms can use weighted data including at least one of (i) a number of the purchased units of the product, (ii) a number of the streams of the product, (iii) a duration of a period of selling the units of the product, (iv) a monetary value of the units of the purchased product, (v) timing of purchases of the units of the product, (vi) a type of the product, (vii) a geographical location of a user of the portal, (viii) a common relationship between a plurality of users of the portal, and a number of sold units of production/commercial versions of the product.

Various other aspects and embodiments of the disclosure are described in further detail below. It has been contemplated that features of one embodiment of the disclosure may be incorporated in other embodiments thereof without further recitation.

The Summary is neither intended nor should be construed as being representative of the full extent and scope of the present disclosure.

All objects, features and advantages of the present disclosure will become apparent in the following detailed written description and in conjunction with the accompanying drawings.

The novel features believed being characteristic of the description are set forth in the appended claims.

### BRIEF DESCRIPTION OF THE DRAWINGS

FIG. 1 depicts a high-level flow diagram illustrating a method for pre-production rating of musical products according to one embodiment of the present disclosure.

FIGS. 2-3 depict exemplary display snapshots illustrating features of a website of the method of FIG. 1 according to one embodiment of the present disclosure.

FIG. 4 depicts a diagram illustrating techniques for rating music evaluation skills of purchasers of pre-production copies of musical products according to one embodiment of the present disclosure.

The images in the drawings are simplified for illustrative purposes and are not depicted to scale. To facilitate understanding, identical reference numerals are used in the drawings to designate, where possible, substantially identical elements that are common to the figures, except that alphanumerical extensions and/or suffixes may be added, when appropriate, to differentiate such elements.

### DETAILED DESCRIPTION

Objects, features and advantages of the present disclosure are discussed below in reference to rhythmic audio compositions, such as (but not exclusively) songs, instrumental music compositions, and other musical titles. Such musical products may be marketed and sold as online downloads or in a form of transferable computer-readable media.

It has been contemplated that these objects, features or advantages are applicable to other products available in a digital form or in a form of computer-readable media, including computer games, applications/programs for processor-enabled apparatuses (e.g., computers, cell phones, personal digital assistants, tablets, etc.), among other products.

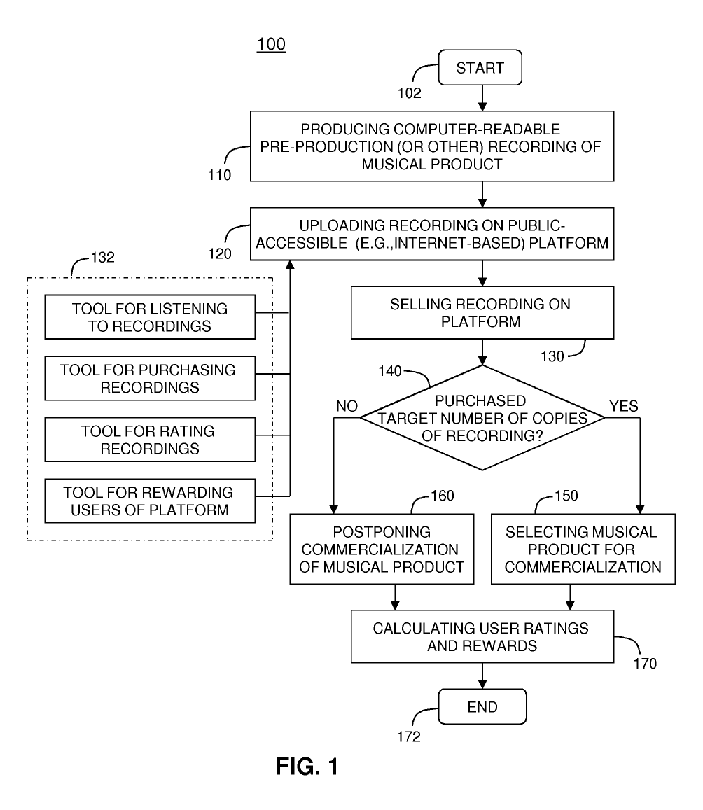

FIG. 1 a high-level flow diagram illustrating an exemplary method 100 for pre-production rating of musical products according to one embodiment of the present disclosure.

The method 100 starts at step 102 and proceeds to step 110. At step no, a digital file of a pre-production computer-compatible edition of a musical product is produced. This digital file (referred to hereafter as a “recording”) includes the musical product in a form of machine readable computer code that may be saved or encoded in computer-readable media (e.g., hard drive, CD/DVD disc, memory card, USB drive, and the like) or streamed from a remote storage server (e.g., cloud).

The musical product may include, for example, at least one recording of a rhythmic audio composition. In some implementations, the pre-production computer-compatible edition of the musical product can be a promotional, trial version or partial version thereof, which may include portions of at least one musical title of the product.

The recording of the musical product may be produced, at a fraction of costs of fabricating a production version of the product, by, for example, a creator or owner of the musical product or by a music recording enterprise. Because of finite resources, promotion, and related expenses, are also typically kept to a minimum at this stage.

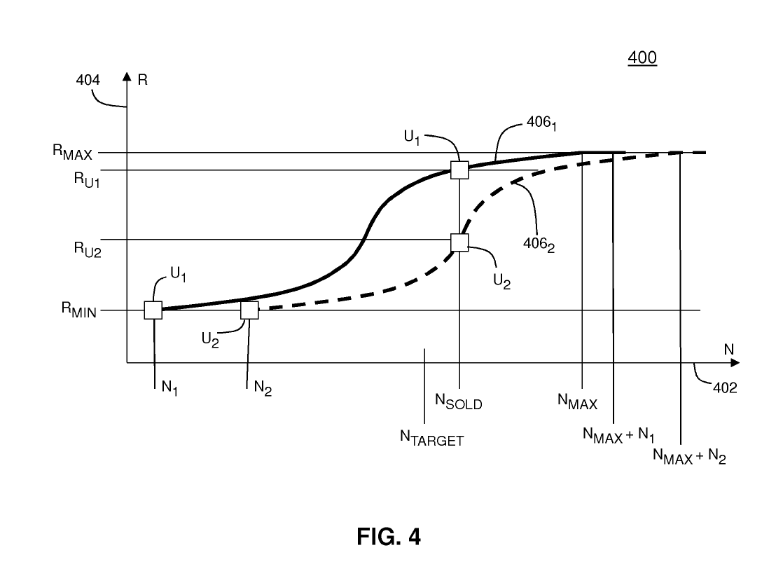

At step 120, the recording of the musical product is uploaded on an Internet-based platform adapted for marketing recordings or respective musical products uploaded thereto, executing online sales of copies of the recordings to users of the platform, and rating the musical products. Optionally, the platform is also adapted for rewarding the users of the platform, as discussed in detail below in reference to step 170 and with respect to FIG. 4. Herein, the terms “reward” and “rebate” and same grammatical forms thereof are used interchangeably.

In one of preferred embodiments, the platform can be a website accessible by the general public and hosted on at least one server of a network coupled to the Internet. The website includes graphical user interface (GUI) having tools which allow users to perform at least a portion of processing steps of the method 100. Illustratively, GUI-supported tools 132 for listening, purchasing, and rating recordings and rewarding users of the platform are shown.

At step 130, the recording is marketed and offered for sale on the Internet-based platform at step 120. Copies of the recording may be purchased by users of the platform during a pre-determined time period ΔT (e.g., at least one minute, hour, day, week or month). A number of the recordings purchased during the time period ΔT, can be used as an objective measure of a commercial potential of the respective musical product, among other factors.

In some embodiments, during the time period ΔT, the users can instantly promote the recording by providing to their addressees links to the platform and/or recording through various means of online communications, such as e-mail, Facebook, Twitter, and the like.

Purchased copies of the recording are generally available in a digital form as computer downloads or, optionally, in a form of pre-encoded computer-readable media, such as pre-encoded CD/DVD discs, memory cards, USB drives, stored in the “cloud” for on-demand access to the digital stream, and the like.

At step 140, the method 100 queries whether a pre-set number (referred to as “target number”) of copies of the recording was purchased during the time period ΔT by users of the platform. The target number can correspond, for example, to a minimal number of sales required to offset costs of commercialization of the respective musical product, or can be chosen based on other criteria, such as marketing, promotion, touring, costs, and the like. Furthermore, the target number can simply be a statistically significant number expressed as a percentage or ratio so as to demonstrate that for a given number of individuals that listened to the recording, a particular subset of the individuals committed to it financially.

If the query of step 140 is answered positively, the method 100 proceeds to step 150. At step 150, a musical product of which at least the target number of copies of the recording (i.e., copies of the pre-production edition of the musical product) were purchased by users of the platform, is identified as a candidate for commercialization. However, other criteria can be used in addition or in the alternative to simply the number of units sold. For example, the count of full or partial streams, the number of credits a user chooses to apply, or the extent (e.g. first, second, third . . . degrees of separation) of the network key influencers that committed financially. In some implementations, users of the platform can post a link to the recording or other work on a social media website (e.g., Spotify, YouTube, Facebook, Twitter, and the like). Web traffic relating to and resulting from such postings can also be used as criteria for commercialization. Moreover, to the extent that the recording or other work is independently deposited on such a social media website, to the extent available, that activity and views or streams of that activity can be used as criteria for commercialization or further investment. For example, in some implementations, the disclosed embodiments can be configured to review and “scrape” or obtain data from popular websites (social media and other) for stream counts to factor into ratings. Optionally, portions of sales revenue may be used to mitigate costs of the product's commercialization.

If the query of step 140 is answered in the negative, the method 100 then proceeds to step 160. At step 160, commercialization can be chosen to be postponed for a musical product of which less than the target number of copies of the pre-production edition thereof were purchased by users of the platform, or that does not meet other criteria.

At step 170, applying pre-defined algorithms, the method 100 can calculate ratings of and optional rewards for users of the platform of step 120.

The users can be rewarded, for example, in a form of rebates or other indicia of recognition, for their skills in selecting prospective musical products and participation in pre-production rating of these products. In general, user rewards can be based on numerical values of user ratings and may include monetary rewards, tangible rewards (e.g., valuable gifts), and non-tangible rewards, or compliments, such as honorary ranks, diplomas, etc. or an increase in a user rating metric. In some implementations, users who did not buy particular recordings but provided valuable comments related thereto, can also be rewarded accordingly. In some implementations, the artist creating the recording can select one or more rewards for users from a preselected list, and/or a custom list of rewards.

Algorithms for calculating the user ratings may use, e.g., weighted data for a number of purchased copies of the recording and/or the number of full or partial streams, a monetary value of the purchased copies or streams, timing of purchases, a genre of the recording, duration of the time period ΔT for purchasing the copies of the recording, or a number of sold copies of production/commercial editions of the recording, among other parameters.

A value of a monetary reward can be a linear or non-linear function of a user rating with respect to a particular recording, or can be averaged for purchases of the same or different musical genres, among other factors.

Upon completion of step 170, the method 100 ends at step 172.

In other embodiments of the method 100, the platform of step 120 may also be used for selling low-volume production copies of particular musical products, e.g., to assess acceptance of these products by different consumer verticals or sectors of a local, regional, national, or worldwide marketplace, as desired.

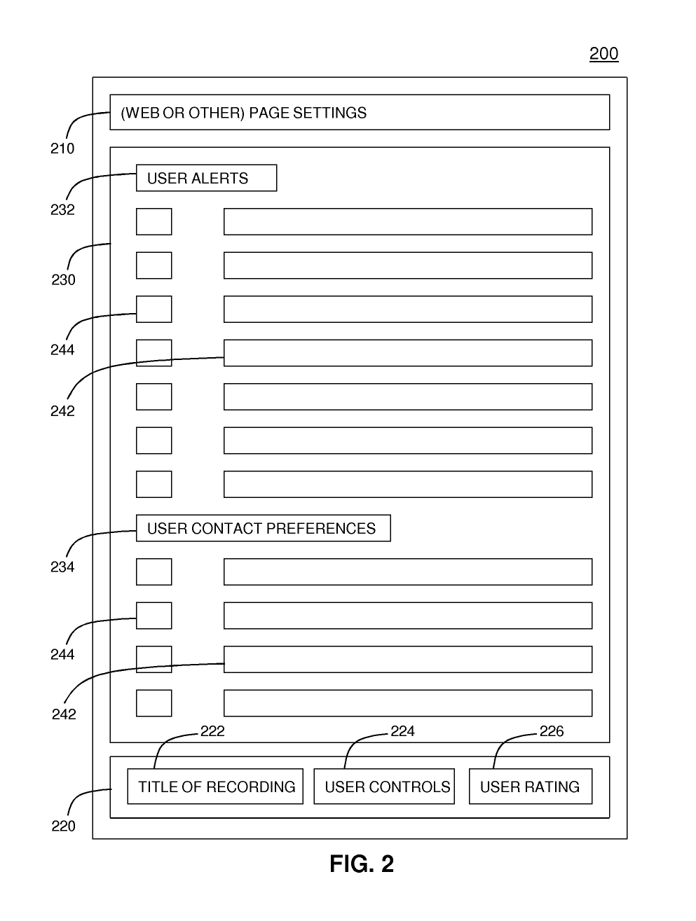

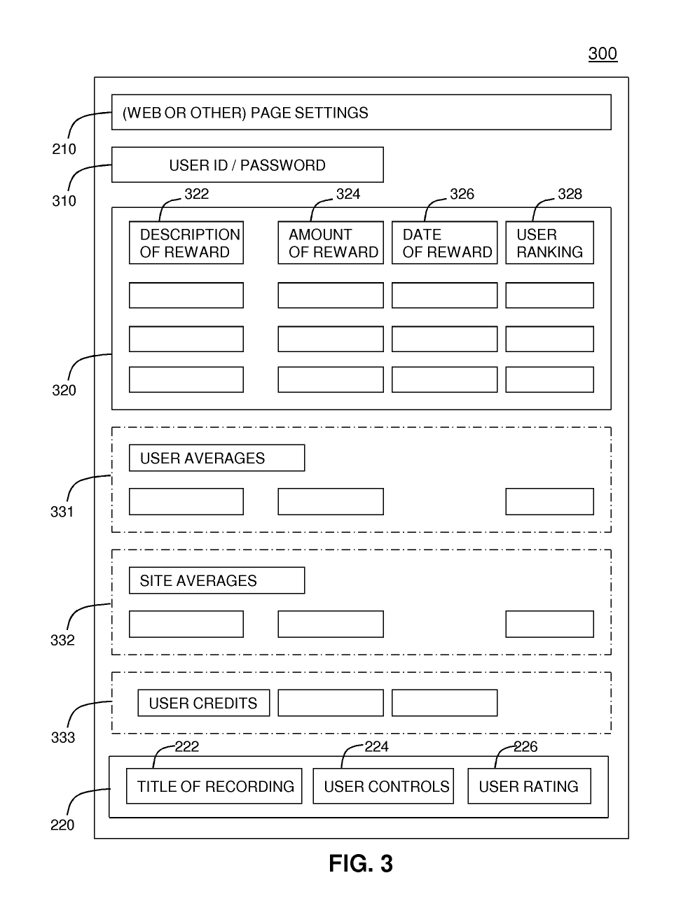

FIG. 2 and FIG. 3 depict exemplary GUIs 200 and 300, respectively, which illustrate exemplary webpages of the network (e.g., Internet)-based platform of the method 100 of FIG. 1 according to one embodiment of the present disclosure.

A user of the platform can activate GUI-supported tools thereof by selecting particular graphical elements or symbols on a respective webpage. The depicted pages are optionally formatted for viewing on mobile computing devices, such as cell phones, personal digital assistants, and the like.

Referring to FIG. 2, the GUI 200 depicts a user webpage including a header block 210 “Webpage Settings”, a footer block 220 having fields “Title of Recording” 222, “User Controls” 224, and “User Rating” 226, and a main block 230 having fields “User Alerts” 232, “User Contact Preferences” 234 including pluralities of data blocks 242 and check blocks 244. It will be appreciated that the aforementioned fields are merely illustrative examples.

Referring to FIG. 3, the GUI 300 depicts a user rewards webpage including the header block 210, the footer block 220, a identification/security block 310, a records block 320 having columns “Description of Reward” 322, “Amount of Reward” 324, “Date of Reward” 326 and “User Ranking” 328. At least a portion of these columns can extend in fields “User Averages” 331, “Website Averages” 332 and “User Credits” 333, respectively.

FIG. 4 depicts a diagram 400 illustrating techniques for rating music evaluation skills of purchasers of the copies of recordings according to one embodiment of the present disclosure. Referring to FIG. 1, purchases of the copies of the recording are performed at step 130 of the method 100. For clarity, reference is made to FIGS. 1 and 4 simultaneously.

In particular, the diagram 400 includes an exemplary graph 406 used for determining a user rating R (y-axis 404) of a purchaser of a copy of the recording versus a total number N (x-axis 402) of purchased copies thereof. The graph 406 represents a user rating R as a pre-defined function of the number N of the purchased copies of the recording.

Numerical values of this function vary between a minimum value R_{MIN} and a maximum value R_{MAX}, wherein R_{MIN} corresponds to N=1 (i.e., only one copy of the recording was sold), and R_{MAX} corresponds to a pre-selected number N_{MAX} or greater number of the purchased copies of the recording, respectively.

Referring to step 140 of the method 100 of FIG. 1, when N_{MAX} is greater than the pre-set target number (shown in FIG. 4 as “N_{TARGET}”) of sold copies of the recording, a respective musical product can be identified as a candidate for commercialization. Otherwise, if desired, commercialization of that musical product can be postponed.

To determine a user rating R of a particular user U, a starting point of the graph 406 is placed at a point having an x-coordinate equal to N_{P} and a y-coordinate equal to R_{MIN}, where P is a number of the copies sold to other users prior to a copy purchased by the user U.

As such, users buying copies of the recording while a number of the sold copies thereof is relatively low can achieve higher user ratings R_{U} than users who buy after more copies were sold. Correspondingly, earlier purchasers of copies of the recording can also achieve higher user ratings R_{U} sooner than subsequent purchasers.

Similarly, referring to step 130 of the method 100 of FIG. 1, a purchaser buying a copy of the recording earlier during the time period ΔT, may achieve a higher user rating or achieve such a rating sooner than the subsequent purchasers.

Referring to FIG. 4, a user U₁ (shown in a graph 406₁ depicted with a solid line) buying an N₁-th copy of the recording N₁ of which, in total, a number N_{SOLD} of copies were sold during the time period ΔT, achieves a user rating R_{U1}, and this user could achieve the maximum user rating R_{MAX} when at least (N₁+N_{MAX}) copies of the recording were sold.

Correspondingly, if a user U₂ (shown in a graph 406₂ depicted with a broken line) buys an N₂-th copy of the recording (N₂>N₁), then the user U₂ can achieve only a user rating R_{U2} when the number N_{SOLD} of copies were purchased, and R_{U2}<R_{U1}. Therefore, the user U₂ can achieve the maximum user rating R_{MAX} only after at least (N₂+N_{MAX}) copies of the recording were sold.

In alternate embodiments, a value of the user rating R_{U} may be further adjusted based on a variety of factors, e.g., a genre of the recording or work, an average user rating across different musical genres, a monetary value of the purchased copy(ies), or whether sales of the recording exceeded N_{TARGET}, among other factors. In another embodiment, N can refer to streams, or a combination of copies sold and streams. If a combination of copies and streams, the streams can be combined with the number of copies with an appropriate weighting factor, such as 10, 100, or 1,000 copies would be considered to be equivalent to one copy sold. The weighting factor can be determined dynamically, based on at least one of, for example (i) a comparison of the total number of streams with the total number of recordings sold, (ii) a genre of the work, (iii) the amount of time that the work has been publicly available, (iv) the relative obscurity or frame of the artist, (v) an average user rating, (vi) a price paid for the recording, and the like.

Aspects of the present disclosure have been described above with respect to a pre-production rating of musical recordings, among other products available in a digital form or in a form of computer-readable media. However, this disclosure may alternatively be implemented as a program product, mobile phone app, digital art, videos, and the like.

Processor-readable instructions defining the functions of the present disclosure can be delivered using variety of signal-bearing media, including non-rewritable storage media (e.g., CD/DVD-ROM), or rewritable storage media (e.g., hard drive disk, floppy disk, flash memory, CD/DVD). Such signal-bearing media, when carrying or encoding computer-readable instructions that direct the functions of this disclosure, represent alternative embodiments thereof.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Descriptions herein of circuitry and method steps and computer programs represent conceptual embodiments of illustrative circuitry and software embodying the principles of the disclosed embodiments. Thus the functions of the various elements shown and described herein may be provided through the use of dedicated hardware as well as hardware capable of executing software in association with appropriate software as set forth herein.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein.

Similarly, it will be appreciated that the system and process flows described herein represent various processes which may be substantially represented in computer-readable media and so executed by a computer or processor, whether or not such computer or processor is explicitly shown. Moreover, the various processes can be understood as representing not only processing and/or other functions but, alternatively, as blocks of program code that carry out such processing or functions.

The methods, systems, computer programs and mobile devices of the present disclosure, as described above and shown in the drawings, among other things, provide for improved promotional platforms for musical recordings, computer games, and the like, and aspects thereof. It will be apparent to those skilled in the art that various modifications and variations can be made in the devices, methods, software programs and mobile devices of the present disclosure without departing from the spirit or scope of the disclosure. Thus, it is intended that the present disclosure include modifications and variations that are within the scope of the subject disclosure and equivalents.

What is claimed is:

1. A method for promoting and vetting a pre-production recording of a musical product, comprising:
receiving a computer-compatible recording of the musical product via processor from a first user;
uploading the recording of the musical product onto a computer network accessible platform by a plurality of listeners via processor;
providing the platform with tools to permit a first listener to listen to the musical product and commit to a pre-buy commitment of the musical product via processor; and
rating the first listener via processor based at least in part on a number of pre-buy commitments made for the musical product by other listeners after the first listener commits to the pre-buy commitment.

2. The method of claim 1, wherein the musical product includes at least one recorded audio composition.

3. The method of claim 1, wherein the recording includes a preliminary, demo or production version of the musical product.

4. The method of claim 1, wherein the platform is hosted on at least one server of a communications network.

5. The method of claim 1, further comprising distributing a final version of the musical product to listeners that committed to the pre-buy commitment.

6. The method of claim 1, wherein pre-commitments for the musical product are escrowed via processor, until a predetermined threshold is reached.

7. The method of claim 6, wherein the artist is provided with a letter of credit for paying for a production master of the musical product via processor.

8. The method of claim 1, further comprising translating the rating of the first listener into a monetary rewards for the first listener.

9. The method of claim 1, further comprising establishing an award allocation pool to provide monetary incentive for listeners to participate, wherein listeners with the highest ratings are provided with monetary rewards from the award allocation pool.

10. The method of claim 9, wherein revenue generated from the musical product is divided among a creator of the recording, a distribution company, and the award allocation pool.

11. The method of claim 9, wherein the award allocation pool is used to attract a specific type of listener.

12. The method of claim 11, wherein the specific type of listener is associated with a specific geography.

13. A method for determining commercial viability of a digital product available in a digital form comprising:
receiving a computer-compatible digital file of the digital product via processor;
uploading the digital file onto a network accessible by a plurality of users via processor;
providing the network with an interface having with tools for evaluating the digital product and committing to a pre-buy commitment of the digital product via processor; and
rating at least one of the users based at least in part on a number of pre-buy commitments made for the digital product by other users after the at least one listener commits to the pre-buy commitment.

14. The method of claim 13, wherein the digital product includes a preliminary, demo or production version of the digital product.

15. The method of claim 13, wherein the digital product includes a production version for which a provider of the digital product is seeking at least one objective indicator of commercial viability.

16. The method of claim 13, further comprising:
promoting the digital product through online communication; and
selling the digital product in a computer downloadable format.

17. The method of claim 14, further comprising offering rewards to the at least one user of the digital product via processor.
